(19) United States
(12) Patent Application Publication
(10) Pub. No.: US 2016/0308917 A1
(43) Pub. Date: Oct. 20, 2016

(54) SENSOR INPUT TRANSMISSION AND ASSOCIATED PROCESSES

(71) Applicant: Intel Corporation, Santa Clara, CA (US)

(72) Inventors: Karthik Veeramani, Hillsboro, OR (US); Preston J. Hunt, Portland, OR (US)

(21) Appl. No.: 14/865,585

(22) Filed: Sep. 25, 2015

Related U.S. Application Data
(60) Provisional application No. 62/150,259, filed on Apr. 20, 2015.

(51) Int. Cl. H04L 29/06; H04W 76/02

(52) U.S. Cl. CPC H04L 65/1069; H04W 76/023; H04L 65/608; H04L 65/1089; H04L 65/1093

(57) ABSTRACT

This disclosure describes methods, apparatus, and systems related to sensor input transmission and associated processes. In some embodiments, a source device may establish a wireless connection with a sink device. A video content stream corresponding to content presented on a source device display may be generated. The video content stream may be transmitted to the sink device. A data packet received from the sink device may be identified, the data packet comprising sensor data. An updated video content stream using the sensor data may be generated. The updated video content stream may be transmitted to the sink device.

### RELATED APPLICATIONS

This application claims priority to U.S. Ser. No. 62/150,259, titled “Sensor Input Transmission and Associated Processes,” filed on Apr. 20, 2015, the contents of which is hereby incorporated by reference in its entirety.

### TECHNICAL FIELD

This disclosure generally relates to systems and methods for wireless communications and, more particularly, to enabling passing of sensor inputs.

### BACKGROUND

Wireless devices come in a variety of different sizes with different capabilities. Wireless devices may be enabled to utilize technologies, such as Miracast, which is a protocol to connect devices using a Wi-Fi Direct connection. For example, a device, such as a Wi-Fi enabled television, may be utilized as a wireless display mechanism (e.g., a receiver or sink device) for viewing content transmitted by a primary device (e.g., a transmitter or source device), such as a smartphone using a wireless display standard, which may enable the content from the smartphone may be displayed on the television. Various types of information may be transmitted between the transmitter and the receiver using the wireless display standard.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 depicts a data flow diagram illustrating an example network environment of an illustrative wireless communication system, according to one or more example embodiments of the disclosure.

FIG. 2 depicts an example extended listing of input types as defined by a wireless display standard specification, according to one or more example embodiments of the disclosure.

FIG. 3 depicts an example data format table of a particular sensor input type, according to one or more example embodiments of the disclosure.

FIG. 4 depicts an example process flow for transmitting sensor inputs between two or more devices, according to one or more example embodiments of the disclosure.

FIG. 5 depicts an example of a communication device, according to one or more example embodiments of the disclosure.

FIG. 6 depicts an example of a radio unit, according to one or more example embodiments of the disclosure.

FIG. 7 depicts an example of a computational environment, according to one or more example embodiments of the disclosure.

FIG. 8 depicts another example of a communication device, according to one or more example embodiments of the disclosure.

The detailed description is set forth with reference to the accompanying drawings, which are not necessarily drawn to scale. The use of the same reference numbers in different figures indicates similar or identical items. Illustrative embodiments will now be described more fully hereinafter with reference to the accompanying drawings, in which some, but not all embodiments of the disclosure are shown. The disclosure may be embodied in many different forms and should not be construed as limited to the embodiments set forth herein; rather, these embodiments are provided so that this disclosure will satisfy applicable legal requirements.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The word “exemplary” is used herein to mean “serving as an example, instance, or illustration.” Any embodiment described herein as “exemplary” is not necessarily to be construed as preferred or advantageous over other embodiments.

Embodiments disclosed herein generally pertain to wireless networks and provide certain systems, methods, and devices for transmitting sensor inputs between two or more Wi-Fi-enabled wireless devices in various Wi-Fi networks, including, but not limited to, IEEE 802.11ax, IEEE 802.11n, IEEE 802.11ac, and/or Wi-Fi Certified Miracast standards. In some embodiments, Miracast Wi-Fi technologies may be utilized to facilitate communication of sensor inputs from a receiver to a transmitter. More particularly, embodiments described herein may be directed to proposing data format definitions for various sensor input types in a User Input Back Channel (UIBC)-Generic portion of a Miracast standard specification.

The systems and methods described herein are directed to sensor input transmission associated with a wireless display standard. In some embodiments, a user may interact with a source device, such as a smartphone, to establish a direct wireless connection with a sink device, such as a tablet. The source device may query the sink device during capability negotiation to determine the types of input types supported by the sink device. The sink device may generate a list that includes a subset of the input types available in the wireless display standard specification and transmit the list to the requesting source device.

Upon completion of the capability negotiations with the sink device, the source device may generate a video content stream. The video content stream may mirror or otherwise correspond to content presented and/or rendered on the display of the source device. The video content stream may be transmitted to the sink device. The sink device may display or render the video content stream on a display of the sink device. Thus, the display of the sink device mirrors the content shown on the display of the source device. In some embodiments, the video content stream may also include content that is not displayed on the source device, but is displayed on the sink device. For example, an extended or second display or content “passed through” from an external source, such as a video streaming provider (e.g., YouTube™ or Netflix™).

In some embodiments, the source device may transmit a request to the sink device for inputs for one or more input types supported by the sink device. The sink device may capture the requested data. For example, the sink device may capture data using an input/output device of the sink device or one or more sensor devices (e.g., camera, microphone, gyroscope, accelerometer, thermometer, etc.). The sink device may process the captured data. For example, the captured data may be converted into a format that correspond to the requested input type. The sink device may generate a data packet that includes the processed captured data and may transmit the data packet to the source device.

The source device may receive the data packet, process the data packet and may provide the processed captured data as input to an input system (e.g., requesting application executing on the source device). The source device may then generate or update the video content stream using the processed captured data and transmit the generated or updated video content stream to the sink device to be presented on the display of the sink device.

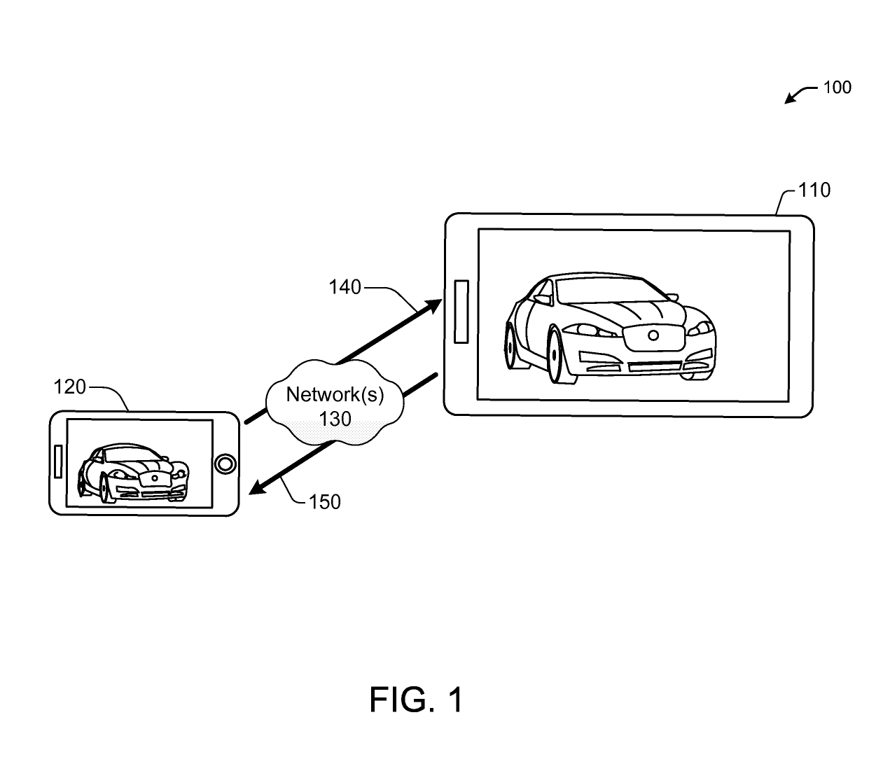

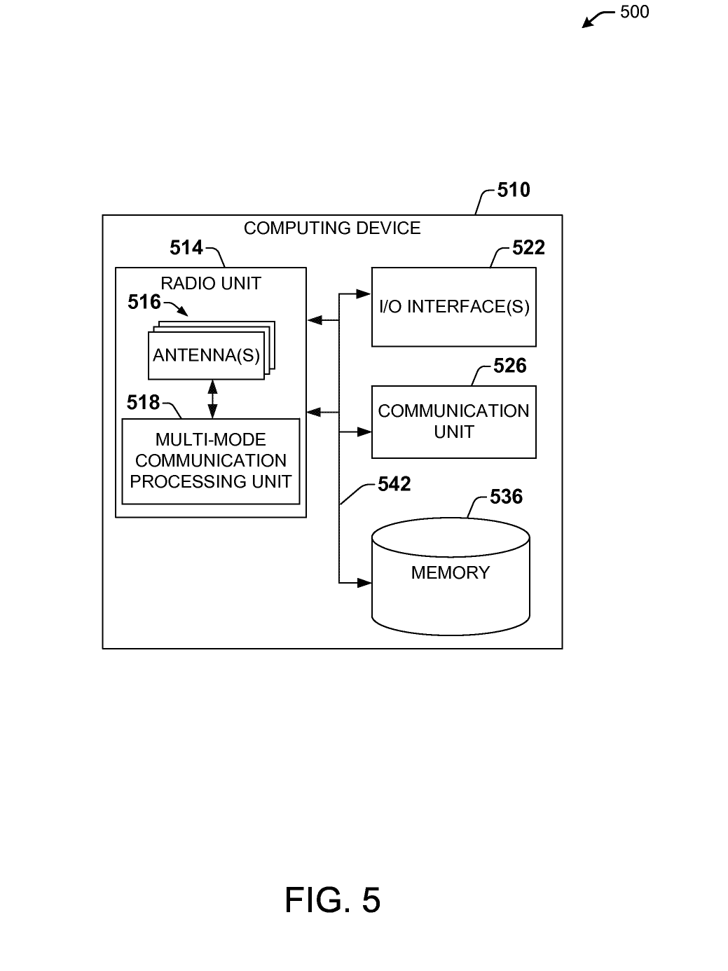

FIG. 1 is a data flow diagram illustrating an example network environment 100, according to some example embodiments of the present disclosure. Network environment 100 can include a sink device 110 and/or a source device 120, which may communicate in accordance with IEEE 802.11 communication standards or Miracast, over a network 130. In some embodiments, the sink device 110 and/or the source device 120 can include one or more computer systems similar to that of the exemplary functional diagrams of FIGS. 5-8.

The term “sink device” 110 as used herein may refer to a display device such as a monitor, a wired device, a wireless mobile device, a smart board, a projector and/or screen, a television, a smart television, a computing device, a laptop computer, a tablet, a smart phone, and/or some other similar terminology known in the art. The sink device 110 may be either mobile or stationary and may utilize wireless and/or wired communication technologies.

The term “source device” 120 may refer to a wireless communication device such as an audio/video receiver, a computing device, a handheld device, a mobile device, a wireless device, a user device, and/or user equipment (UE), a cellular telephone, a smartphone, a tablet, a netbook, a wireless terminal, a laptop computer, a femtocell, a High Data Rate (HDR) subscriber station, an access point, an access terminal, a printer, a display, a monitor, a scanner, a copier, a facsimile machine, a personal communication system (PCS) device, and/or the like. The source device 120 may be either mobile or stationary and may utilize wireless and/or wired communication technologies.

The sink device 110 and the source device 120 may be configured to communicate with each other via one or more communications networks 130, either wirelessly or wired. Any of the communications networks 130 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

As used herein, the term “communicate” may include transmitting, receiving, or both transmitting and receiving between the sink device 110, the source device 120, and/or another device or system. Similarly, the bidirectional exchange of data between two devices (both devices transmit and receive during the exchange) may be described as “communicating,” when only the functionality of one of those devices is being described. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some embodiments may be used in conjunction with various devices and systems, for example, the sink device 110, the source device 120, a transmitter, a receiver, a display, a monitor, a smart phone, a tablet, a handheld device, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a user device, a station (STA), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Orthogonal Frequency-Division Multiple Access (OFDMA), Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), a UIBC and/or Wi-Fi, or the like. Other embodiments may be used in various other devices, systems, and/or networks.

In some embodiments, the sink device 110 and/or the source device 120 may include one or more communications antennae. Communications antennae may be any suitable type of antenna corresponding to the communications protocols used by the sink device 110 and/or the source device 120. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the STAs.

The sink device 110 and/or the source device 120 may include any suitable radio and/or transceiver for transmitting and/or receiving radio frequency (RF) signals in the bandwidth and/or channels corresponding to the communications protocols utilized by the sink device 110 and/or the source device 120 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards and/or Miracast standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

The sink device 110 and/or the source device 120 may be operable by one or more users (not shown). Typically, a user operates (e.g., provides user input using) the source device 120 while viewing the mirrored content on the sink device 110. For example, the user may control a character in a video game using the source device 120 and may view the character's actions on the sink device 110. In some embodiments, a user may interact with the sink 110 device and the input may be transferred back to the source device 120.

FIG. 1 illustrates a wireless display setup for enabling communication between the sink device 110 and the source device 120 using a wireless display standard, such as Miracast. A wireless display standard, such as Miracast, enables a user to pass input received from a user at the source device 120 to the sink device 110. At data exchange 140, the source device 120 may generate and transmit a video content stream of the screen content from the source to the sink device 110. In some embodiments, the wireless connection between the source device 120 and the sink device 110 may be a transmission control protocol (TCP) connection.

At data exchange 150, the sink device 110 may capture data, such as user input and/or sensor data using one or more input devices or sensor devices, and may transmit the captured data back to the source device 120. The captured data may be transmitted using a UIBC protocol. In some embodiments, the UIBC-Generic section of a wireless display standard, such as the Miracast specification, may enable passing pre-determined input types, such as keyboard input, mouse coordinates, and/or the like received from the source device 120 to the sink device 110 so that any actions associated with the received inputs are displayed by the sink device. In this manner, the user may utilize the source device 120 to control various aspects of content displayed by the sink device 110. Embodiments disclosed herein are directed to systems and methods for passing sensor inputs captured on a sink device 110 to a source device 120 for processing.

Existing UIBC-Generic sections of a Miracast standard typically addresses a limited number of user inputs received by the source device 120 such as keyboard, mouse, touch, and some conceptual inputs like pinch and zoom. Data received from sensors of the source device 120, such as gyroscopes and/or accelerometers, typically cannot be passed from the source device 120 to the sink device 110 directly, unless translated (e.g., converted) into data of a format that is within a scope of the protocol. Currently, no solutions that pay attention to passing sensor data from a remote display device (e.g., the source device 120) to the primary device (e.g., the sink device 110) exist.

For example, a user may connect his phone (e.g., source device 120) to a tablet (e.g., sink device 110) and launches a car racing video game application on the phone (e.g., source device 120), where the car racing video game requires the user to physically rotate his tablet (e.g., sink device 110), like he would a steering wheel, to control a car in the car racing video game. The user may rotate his tablet (e.g., sink device 110) to steer, which is mirrored in a display of the car racing video game produced by the phone (e.g., source device 110). The tablet (e.g., sink device 110) receives the user input inputted by the user on his tablet (e.g., sink device 110) from a gyroscope sensor built into his tablet (e.g., sink device 110). The user's tablet (e.g., sink device 110) then calculates and transmits a rate of rotation along X, Y, and/or Z axes to the phone (e.g., source device 120) using a data format specified by a UIBC-Generic section of a Miracast standard as disclosed herein. The phone (e.g., source device 110) receives and injects this rate of rotation data into its corresponding sensor's input system of the car racing video game application, and the car racing video game application receives a rotation event associated with the rate of rotation data calculated and/or produced by the tablet (e.g., sink device 110). The game considers this as an input from a sensor of the phone (e.g., source device 110), and controls the game car (e.g., a character, and/or the like) in the video game. In this manner, the user may utilize his tablet to control a game car of a video game installed and running on the phone.

As another example, a user may connect his phone (e.g., source device 120) to a display (e.g., sink device 110), which has hardware buttons to adjust screen brightness. When these buttons are pressed, the display (e.g., sink device 110) could measure an ambient light level and transmit the measured light level to the phone (e.g., source device 120), which could adjust screen brightness on the phone (e.g., source device 120) accordingly. In this manner, the user may provide control of his phone (e.g., source device 120) using the display (e.g., sink device 110).

In some embodiments, inputs from the sink device 110 are transmitted to the source device 120 and/or inputs from the source device 120 are transmitted to the sink device 110, using a protocol called User Input Back Channel (UIBC), which is a communication method that runs over TCP. However, embodiments described herein can be applied to any wireless (or even wired) display mechanism, any protocol, and/or standard that feeds inputs between devices 110, 120.

Typically, the UIBC-Generic protocol has the following high level steps, defined by a Miracast standard specification version 1.0 or 1.1. In some embodiments, the source device 120 may query the sink device 110 as to whether the sink device 110 supports UIBC, as well as which input types (e.g., keyboard, touch, gestures, and/or the like) during capability negotiation, using a parameter such as wfd2-uibc-capability. The sink device 110 may respond to the query of the source device 120 by providing to the source device 120 a list of input types supported by the sink device 110. For example, a UIBC-Miracast specification may define keyboard, mouse, pinch, zoom, rotate, single-touch and multi-touch input type capability, and the sink device 110 determines and/or identifies a subset of input types including only input types that are supported by the sink device 110. The source device 120 may receive this list of supported input types and configures itself and/or any applications accordingly.

In some embodiments, the source device 120 may request the sink device 110 to transmit inputs for a subset of the input types supported by the sink device 110. The source device 110 may generate a TCP connection for UIBC transmission according to the Miracast specification, and the sink device 110 may connect to the generated TCP connection. Fourth, as inputs occur at the sink device 110 (e.g., are received by the sink device 110 from a user), the sink device 110 may generate a TCP data packet containing data associated to (e.g., corresponding to) the received input and/or input type in a format corresponding to that input type. The generated TCP data packet may then be transmitted from the sink device 110 to the source device 120 using UIBC transmission according to the Miracast specification corresponding to input type of received input. The source device 120 may receive the TCP data packet and injects the TCP data packet into a local device (e.g., an application). The source device 120 may or may not process the TCP data packet to identify input data included in the TCP data packet, convert a format of data, and/or the like. In this manner, an experience of input being received locally (e.g., by the source device 120 directly) is simulated.

In some embodiments, the source device 120 may query the sink device 110 during capability negotiation using a new parameter called wfd2-uibc-capability. This parameter may be used to determine whether the sink device 110 supports any new sensor inputs proposed herein (e.g., any sensor inputs not previously defined as an input type in the UIBC portion of the Miracast specification). The sink device 110 may respond with a subset of the following new input types: “Gyroscope;” “Accelerometer;” “AmbientTemperature;” “Gravity;” “Light;” “MagneticField;” “Orientation;” “Pressure;” “Proximity;” and/or “RelativeHumidity.” The response of the sink device 110 may also include other inputs defined in the Miracast 1.0 specification, such as keyboard and mouse inputs. In some embodiments, new sensor inputs may also be expressed using a vendor-specific extensions that is not predefined in the specification.

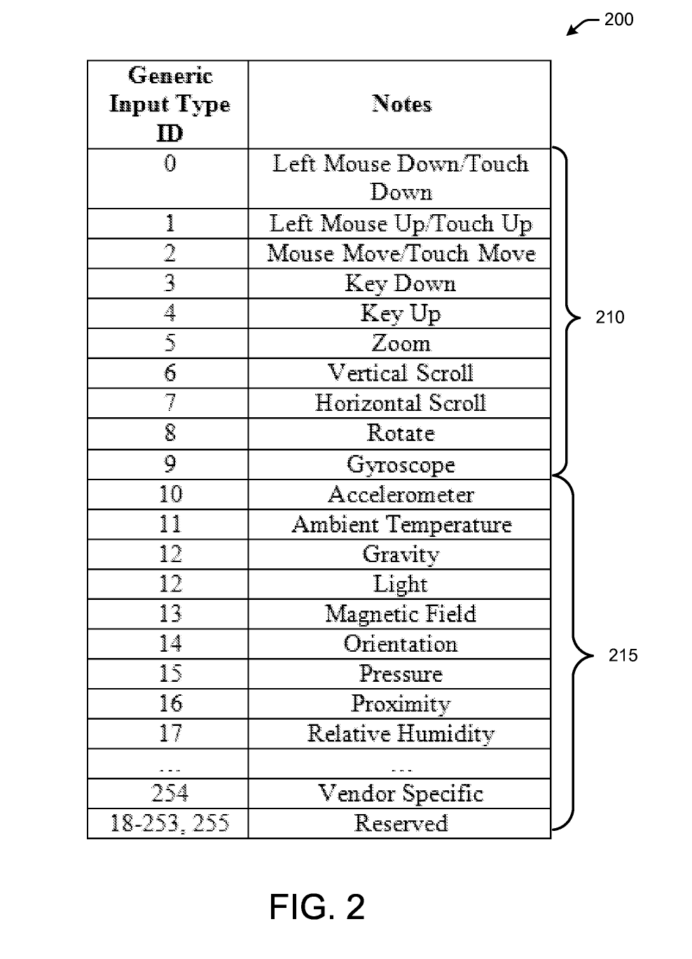

After a UIBC connection is established over a generated TCP connection, the sink device 110 may be enabled to send received and/or generated sensor inputs (e.g., TCP data packets corresponding to received inputs) for input types that source device 120 requested (e.g., a subset input types of what the sink device 110 supports). In this manner, the sink device 110 may generate and/or transmit inputs of input types of which the source device 120 is aware and/or that the source device 120 is expecting. Further, a data format for each sensor types may be determined by the sink device 110 and/or the source device 120 and/or included in the TCP data packet transmission as illustrated in FIG. 2. FIG. 2 depicts example input types that may be used in a wireless display standard. For example, group 210 (e.g., generic input type identifiers 0-9) may include previously established input types, whereas group 215 (e.g., generic input identifier 9-255) may depict input types included in an extended wireless display standard specification as described herein. The wireless display standard specification may defines one or more input type identification (ID) numbers that correspond to one or more input types. In some embodiments, these input type IDs and/or input types are predetermined by a governing body and are included in a substantially universal wireless display standard. Alternatively, one or more of the input type IDs and/or input types may be modifiable by one or more users (e.g., a vendor, supplier, manufacturer, and/or the like of a device, an application, and/or the like). In this manner, various sensor inputs of new sensor and/or input types generated and/or received by the sink device 110 may be accurately transmitted to the source device 120.

After receiving the TCP data packet from the sink device 110, the source device 120 may identify, parse, and/or format the received sensor data included in the TCP data packet and then inject (e.g., input) the corresponding input data into an input system (e.g., a running application). In some embodiments, applications may listen (e.g., monitor) for receipt of inputs of various input and/or sensor types transmitted by the sink device 110. Further, in some embodiments, sensors of the sink device 110 may act upon the received inputs, as though the event happened locally. For example, if an input received from a user on the sink device 110 prompts a vibration of the sink device 110, then the sink device 120 may also vibrate upon receipt.

In some embodiments, a “vendor specific” sensor and/or input type may be included as one of the input types illustrated by generic input identifier 254 of FIG. 2. This allows for a new sensor or an input device to send data from the sink device 110 to the source device 120 using a proprietary data format. In some embodiments, customization of vendor-specific applications, sensor types, and/or input types may be enabled. Data formats for each sensor type's input may also be included in the UIBC section of the wireless display standard specification.

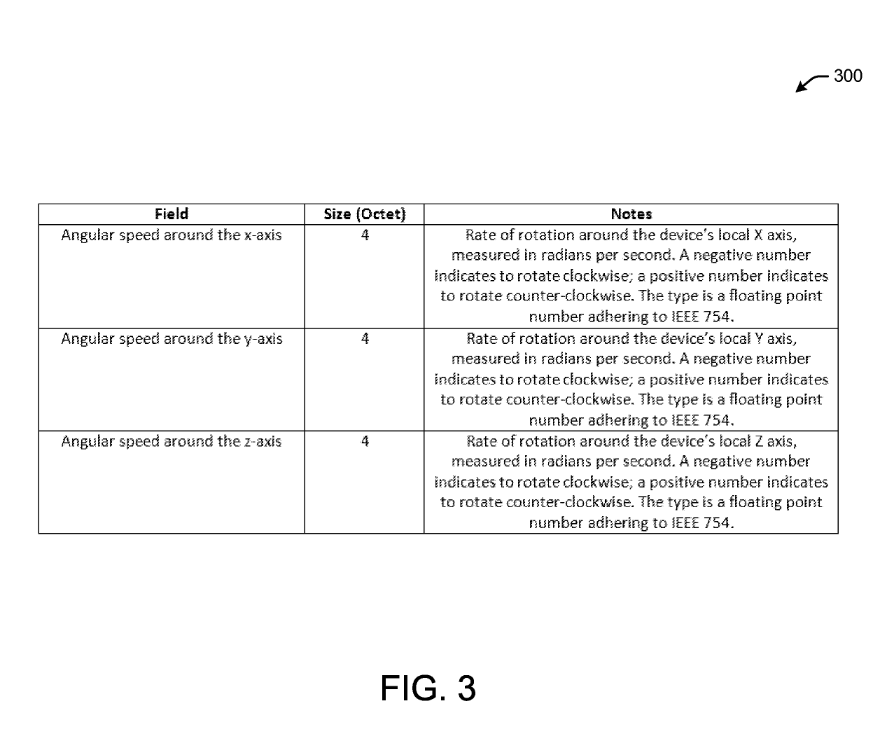

FIG. 3 illustrates an exemplary data format for a “gyroscope” sensor input type. In some embodiments, either the sink device 110 and/or the source device 120 may utilize a data format table as illustrated in FIG. 3 to determine and/or convert a data format of a received input at the sink device 110 into a TCP data packet for an UIBC transmission, or to determine and/or convert a data format of a received TCP data packet into injectable input data at the source device 120. In some embodiments, the data format table may include a field (e.g., input type and/or parameters associated with an input and/or sensor type), a size, and/or notes.

Current wireless display standards may define how to pass inputs from common devices, such as keyboards and mouses, from a wireless display receiver to the transmitter. However, embodiments described herein extends beyond current wireless display standards to include wireless display standards (e.g., in UIBC section of the Miracast standards) relating to various sensor inputs, which have become increasingly more common in mobile devices. Doing this opens a wide array of use cases and/or user input devices, and enhances user experience.

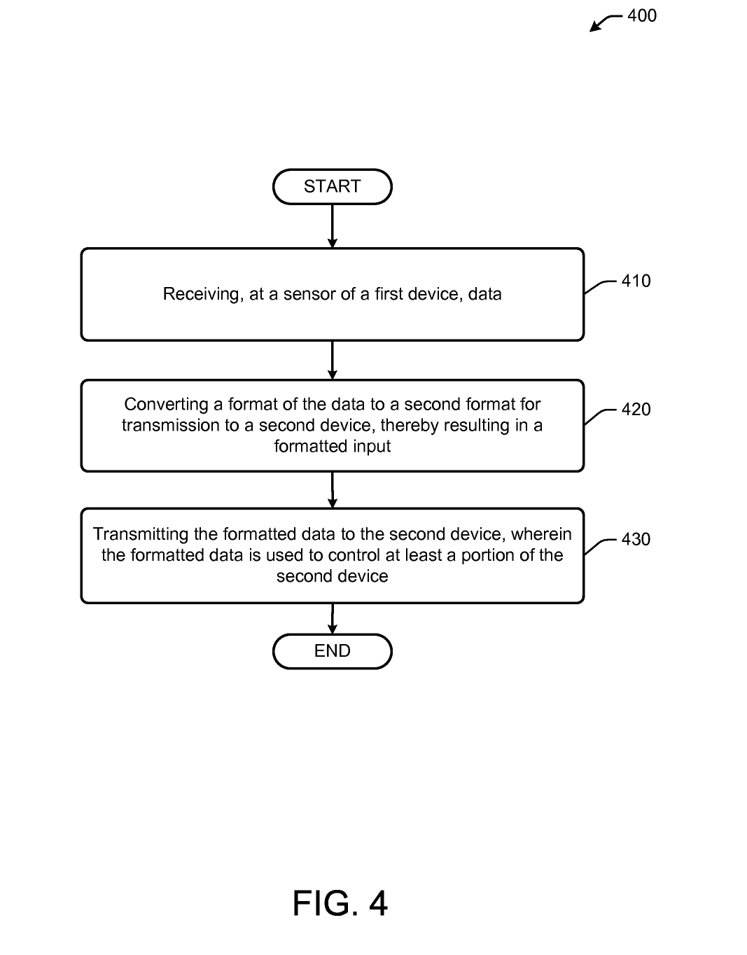

FIG. 4 depicts an example process flow 400 for transmitting sensor inputs between two or more devices, according to one or more example embodiments of the disclosure. At block 410, the process includes receiving, at a sensor of a first device, an input. In some embodiments, the first device may be a sink device 110. In some embodiments, a source device 120 may query the sink device 110 over a network connection to determine whether the sink device 110 supports UIBC during capability negotiations. In some embodiments, the source device 120 may use a parameter wfd2-uibc-capability when querying the sink device 110. The sink device 110 may respond with a list of supported input types. The sink device 110 may generate a list of a subset of the supported input types (e.g., subset of the available input types associated with the wireless display standard. In some embodiments, the list of the subset of supported input types may be generated in response to the request form the source device 120. Examples of supported input types may include, but are not limited to, keyboard, mouse, pinch, zoom, rotate, single-touch, multi-touch, gyroscope, accelerometer, ambient temperature, gravity, light, magnetic field, orientation, pressure, proximity, relative humidity, and/or vendor-specific.

Upon completion of the capability negotiations with the sink device 110, the source device 120 may generate a video content stream. The video content stream may mirror or otherwise correspond to content presented and/or rendered on the display of the source device 120. The video content stream may be transmitted to the sink device 110, where the sink device 110 received the video content stream and displays the video content stream on a display of the sink device 110. Thus, the display of the sink device 110 mirrors the content shown on the display of the source device 120.

In some embodiments, the source device 120 may transmit a request to the sink device 110 to send inputs for the subset of the input types supported by the sink device 110, as indicated by the previously transmitted list. In some embodiments, the source device 120 may disable the sensor on the source device 120 or ignore sensor data from the sensor of the source device 120 that corresponds to the sensor of the sink device 110 associated with the input type in the request from the source device to the sink device 110. The source device may initiate a TCP connection for UIBC and the sink device 110 may connect to the TCP connection.

At block 410, the first device (e.g., sink device 110) may capture data, such as user input captured by one or more I/O devices (e.g., keyboard, mouse, touch screen, etc.) or sensor data captured by one or more sensor devices (e.g., gyroscope, thermometer, pressure gauge etc.). In some embodiments, the sink device 110 may capture data in response to receiving the request from the source device 120.

At block 420, the sink device 110 may process the captured data includes converting a format of the input to a second format for transmission to a second device, thereby resulting in a formatted input. The sink device 110 may generate a data packet (e.g., TCP data packet) that comprises the input data requested by the source device. In some embodiments, the sink device 110 may convert the captured data into a format corresponding to a supported input type and include the formatted captured data in the data packet.

At block 430, the process includes transmitting the formatted data to the second device (e.g., source device 120), wherein the formatted data is used to control at least a portion of the second device (e.g., sink device 110). For example, the source device 120 may receive the data packet (e.g., TCP data packet) transmitted by the sink device 110 and may process the data packet. In some embodiments, the source device 120 may parse data from the data packet and determine the captured data. The captured data may then be injected into an input system of the source device. An example of an input system may be an application executing on the source device 120 and requiring captured data (e.g., user input data or sensor data). The source device 120 may use the captured data from the data packet received from the sink device 110 as input for the input system (e.g., application, etc.). The source device 120 may generate a video content stream corresponding to the display of the source device 120, using the captured data from the data packet and may transmit the video content stream to the sink device 110. The sink device 110 may receive the video content stream and display the video content stream, which corresponds to the display of the source device 120, which used the captured data from the sink device 110 as input into its input system.

FIG. 5 illustrates a block-diagram of an example embodiment 500 of a computing device 510 that can operate in accordance with at least certain aspects of the disclosure. For example, a sink device 110 and/or a source device 120 may be a computing device 510 as described herein. In one aspect, the computing device 510 (e.g., sink device 110 and/or source device 120) can operate as a wireless device and can embody or can comprise an access point, a receiving and/or transmitting station, and/or other types of communication device that can transmit and/or receive wireless communications in accordance with this disclosure. To permit wireless communication, including wireless display Wi-Fi technologies described herein, the computing device 510 includes a radio unit 514 and a communication unit 526. In certain implementations, the communication unit 526 can generate data packets or other types of information blocks via a network stack, for example, and can convey data packets or other types of information block to the radio unit 514 for wireless communication. In one embodiment, the network stack (not shown) can be embodied in or can constitute a library or other types of programming module, and the communication unit 526 can execute the network stack in order to generate a data packet or another type of information block (e.g., a trigger frame). Generation of a data packet or an information block can include, for example, generation of input data, sensor input data, a TCP data packet of a particular data format, control information (e.g., checksum data, communication address(es)), traffic information (e.g., payload data), scheduling information (e.g., station information, allocation information, and/or the like), an indication, and/or formatting of such information into a specific packet header and/or preamble.

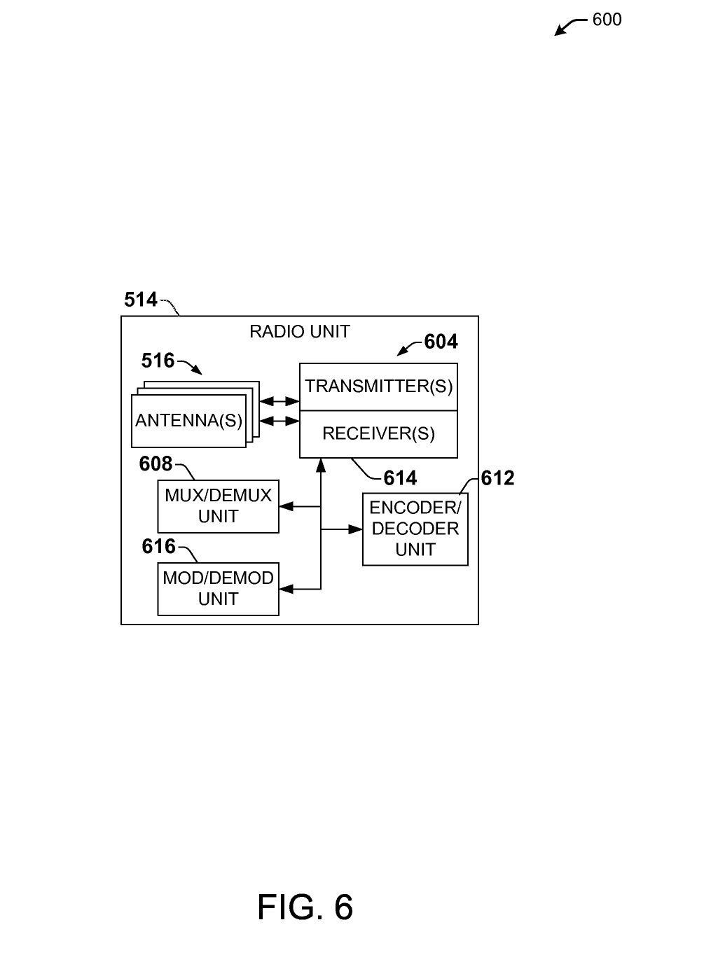

As illustrated, the radio unit 514 can include one or more antennas 516 and a multi-mode communication processing unit 518. In certain embodiments, the antenna(s) 516 can be embodied in or can include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 516 can be physically separated to leverage spatial diversity and related different channel characteristics associated with such diversity. In addition or in other embodiments, the multi-mode communication processing unit 518 that can process at least wireless signals in accordance with one or more radio technology protocols and/or modes (such as MIMO, MU-MIMO (e.g., multiple user-MIMO), single-input-multiple-output (SIMO), multiple-input-single-output (MISO), and the like. Each of such protocol(s) can be configured to communicate (e.g., transmit, receive, or exchange) data, metadata, and/or signaling over a specific air interface. The one or more radio technology protocols can include 3GPP UMTS; LTE; LTE-A; Wi-Fi protocols, such as those of the Institute of Electrical and Electronics Engineers (IEEE) 802.11 family of standards; Worldwide Interoperability for Microwave Access (WiMAX); Miracast; radio technologies and related protocols for ad hoc networks, such as Bluetooth or ZigBee; other protocols for packetized wireless communication; or the like). The multi-mode communication processing unit 518 also can process non-wireless signals (analogic, digital, a combination thereof, or the like). In one embodiment (e.g., example embodiment 600 shown in FIG. 6), the multi-mode communication processing unit 518 can comprise a set of one or more transmitters/receivers 504, and components therein (amplifiers, filters, analog-to-digital (A/D) converters, etc.), functionally coupled to a multiplexer/demultiplexer (mux/demux) unit 608, a modulator/demodulator (mod/demod) unit 616 (also referred to as modem 616), and an encoder/decoder unit 612 (also referred to as codec 612). Each of the transmitter(s)/receiver(s) can form respective transceiver(s) that can transmit and receive wireless signal (e.g., streams, electromagnetic radiation) via the one or more antennas 516. It should be appreciated that in other embodiments, the multi-mode communication processing unit 518 can include other functional elements, such as one or more sensors, a sensor hub, an offload engine or unit, a combination thereof, or the like.

Electronic components and associated circuitry, such as mux/demux unit 608, codec 612, and modem 616 can permit or facilitate processing and manipulation, e.g., coding/decoding, deciphering, and/or modulation/demodulation, of signal(s) received by the computing device 510 and signal(s) to be transmitted by the computing device 510. In one aspect, as described herein, received and transmitted wireless signals can be modulated and/or coded, or otherwise processed, in accordance with one or more radio technology protocols. Such radio technology protocol(s) can include 3GPP UMTS; 3GPP LTE; LTE-A; Wi-Fi protocols, such as IEEE 802.11 family of standards (IEEE 802.ac, IEEE 802.ax, and the like); WiMAX; radio technologies and related protocols for ad hoc networks, such as Bluetooth or ZigBee; other protocols for packetized wireless communication; or the like.

The electronic components in the described communication unit, including the one or more transmitters/receivers 604, can exchange information (e.g., user input, input data, TCP data packets, allocation information, data, metadata, code instructions, signaling and related payload data, multicast frames, combinations thereof, or the like) through a bus 614, which can embody or can comprise at least one of a system bus, an address bus, a data bus, a message bus, a reference link or interface, a combination thereof, or the like. Each of the one or more receivers/transmitters 604 can convert signal from analog to digital and vice versa. In addition or in the alternative, the receiver(s)/transmitter(s) 604 can divide a single data stream into multiple parallel data streams, or perform the reciprocal operation. Such operations may be conducted as part of various multiplexing schemes. As illustrated, the mux/demux unit 608 is functionally coupled to the one or more receivers/transmitters 604 and can permit processing of signals in time and frequency domain. In one aspect, the mux/demux unit 608 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition or in the alternative, in another aspect, the mux/demux unit 608 can scramble and spread information (e.g., codes) according to most any code, such as Hadamard-Walsh codes, Baker codes, Kasami codes, polyphase codes, and the like. The modem 616 can modulate and demodulate information (e.g., data, metadata, signaling, or a combination thereof) according to various modulation techniques, such as OFDMA, OCDA, ECDA, frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, processor(s) that can be included in the computing device 510 (e.g., processor(s) included in the radio unit 514 or other functional element(s) of the computing device 510) can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 612 can operate on information (e.g., data, metadata, signaling, or a combination thereof) in accordance with one or more coding/decoding schemes suitable for communication, at least in part, through the one or more transceivers formed from respective transmitter(s)/receiver(s) 604. In one aspect, such coding/decoding schemes, or related procedure(s), can be retained as a group of one or more computer-accessible instructions (computer-readable instructions, computer-executable instructions, or a combination thereof) in one or more memory devices 534 (referred to as memory 534). In a scenario in which wireless communication among the computing device 510 and another computing device (e.g., the AP, an STA, and/or other types of equipment) utilizes MU-MIMI, MIMO, MISO, SIMO, or SISO operation, the codec 612 can implement at least one of space-time block coding (STBC) and associated decoding, or space-frequency block (SFBC) coding and associated decoding. In addition or in the alternative, the codec 612 can extract information from data streams coded in accordance with spatial multiplexing scheme. In one aspect, to decode received information (e.g., data, metadata, signaling, or a combination thereof), the codec 612 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 612 can utilize, at least in part, mux/demux component 608 and mod/demod component 616 to operate in accordance with aspects described herein.

The computing device 510 can operate in a variety of wireless environments having wireless signals conveyed in different electromagnetic radiation (EM) frequency bands and/or subbands. To at least such end, the multi-mode communication processing unit 518 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion of the EM spectrum. In one aspect, the set of one or more frequency bands can include at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

The computing device 510 can receive and/or transmit information encoded and/or modulated or otherwise processed in accordance with aspects of the present disclosure. To at least such an end, in certain embodiments, the computing device 510 can acquire or otherwise access information, wirelessly via the radio unit 514 (also referred to as radio 514), where at least a portion of such information can be encoded and/or modulated in accordance with aspects described herein. More specifically, for example, the information can include prefixes, data packets, and/or physical layer headers (e.g., preambles and included information such as allocation information), a signal, and/or the like in accordance with embodiments of the disclosure, such as those shown in FIGS. 1-4.

The memory 536 can contain one or more memory elements having information suitable for processing information received according to a predetermined communication protocol (e.g., IEEE 802.11 ac, IEEE 802.11 ax, Miracast, and/or the like). While not shown, in certain embodiments, one or more memory elements of the memory 536 can include computer-accessible instructions that can be executed by one or more of the functional elements of the computing device 510 in order to implement at least some of the functionality for auto-detection described herein, including processing of information communicated (e.g., encoded, modulated, and/or arranged) in accordance with aspect of the disclosure. In some embodiments, the memory 536 may include computer-accessible instructions that may be executed by one or more of the functional element of the computing device 510 (e.g., one or more processors 714) to execute or facilitate execution of the systems and methods described herein. For example, the memory 536 may include a module to initiate and negotiate communication capabilities between the another computing device 510, such as a sink device 110 and/or a source device 120, generating a video content stream which mirrors or otherwise correspond to content presented and/or rendered on the display of the source device; transmits the video content stream to another computing device 536, render the video content stream on a display, and the like. In some embodiments, the module may facilitate capture of sensor data and transmission of the sensor data to another computing device 510. The module may facilitate the transmission of the sensor data to another device. In some embodiments, the module may facilitate the receipt of the sensor data and injection of the sensor data into a corresponding sensor's input system for use by the input system. One or more groups of such computer-accessible instructions can embody or can constitute a programming interface that can permit communication of information (e.g., data, metadata, and/or signaling) between functional elements of the computing device 510 for implementation of such functionality.

In addition, in the illustrated computing device 500, a bus architecture 542 (also referred to as bus 542) can permit the exchange of information (e.g., data, metadata, and/or signaling) between two or more of (i) the radio unit 514 or a functional element therein, (ii) at least one of the I/O interface(s) 522, (iii) the communication unit 526, or (iv) the memory 536. In addition, one or more application programming interfaces (APIs) (not depicted in FIG. 5) or other types of programming interfaces that can permit exchange of information (e.g., trigger frames, streams, data packets, allocation information, data and/or metadata) between two or more of the functional elements of the client device 510. At least one of such API(s) can be retained or otherwise stored in the memory 534. In certain embodiments, it should be appreciated that at least one of the API(s) or other programming interfaces can permit the exchange of information within components of the communication unit 526. The bus 542 also can permit a similar exchange of information.

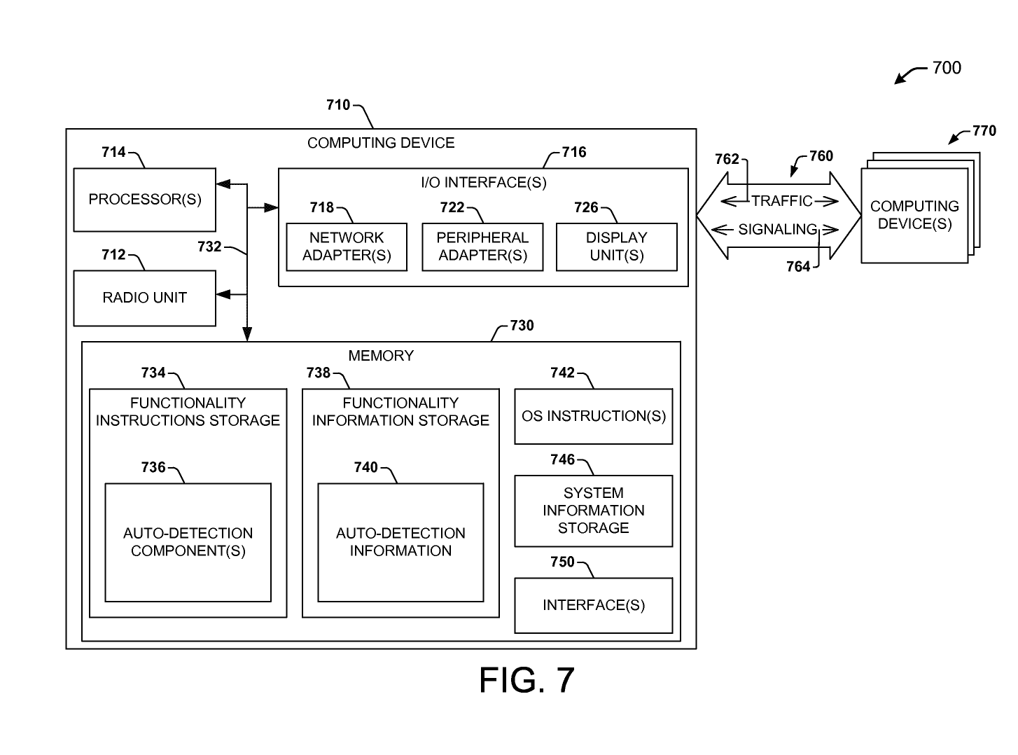

FIG. 7 illustrates an example of a computational environment 700 in accordance with one or more aspects of the disclosure. The example computational environment 700 is only illustrative and is not intended to suggest or otherwise convey any limitation as to the scope of use or functionality of such computational environments' architecture. In addition, the computational environment 700 should not be interpreted as having any dependency or requirement relating to any one or combination of components illustrated in this example computational environment. The illustrative computational environment 700 can embody or can include, for example, the computing device 710, an access point (AP), a wireless communication station (STA), and/or any other computing device that can implement or otherwise leverage the auto-detection features described herein. In some embodiments, the memory 730 may comprise a module that is responsible for the facilitation of the sensor input transmission and associated processes. For example, the computing device 710 may be a sink device 110 and/or a source device 120 which may communicate with other computing devices 770 as described herein. In some embodiments, a source device 120 may communicate with one or more sink devices 110, as described herein.

The computational environment 700 represents an example of a software implementation of the various aspects or features of the disclosure in which the processing or execution of operations described in connection with auto-detection described herein, including processing of information communicated (e.g., encoded, modulated, and/or arranged) in accordance with this disclosure, can be performed in response to execution of one or more software components at the computing device 710. It should be appreciated that the one or more software components can render the computing device 710, or any other computing device that contains such components, a particular machine for facilitating long training field design described herein, including processing of information encoded, modulated, and/or arranged in accordance with aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible instructions that embody a software component can be assembled into one or more program modules, for example, that can be compiled, linked, and/or executed at the computing device 710 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 710 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with auto-detection, including processing of information communicated (e.g., encoded, modulated, and/or arranged) in accordance with features described herein, can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 710 can comprise one or more processors 714, one or more input/output (I/O) interfaces 716, a memory 730, and a bus architecture 732 (also termed bus 732) that functionally couples various functional elements of the computing device 710. The bus 732 can include at least one of a system bus, a memory bus, an address bus, or a message bus, and can permit exchange of information (data, metadata, and/or signaling) between the processor(s) 714, the I/O interface(s) 716, and/or the memory 730, or respective functional element therein. In certain scenarios, the bus 732 in conjunction with one or more internal programming interfaces 750 (also referred to as interface(s) 750) can permit such exchange of information. In scenarios in which processor(s) 714 include multiple processors, the computing device 710 can utilize parallel computing.

The I/O interface(s) 716 can permit or otherwise facilitate communication of information between the computing device and an external device, such as another computing device, e.g., a network element or an end-user device. Such communication can include direct communication or indirect communication, such as exchange of information between the computing device 710 and the external device via a network or elements thereof. As illustrated, the I/O interface(s) 716 can comprise one or more of network adapter(s) 718, peripheral adapter(s) 722, and display unit(s) 726. Such adapter(s) can permit or facilitate connectivity between the external device and one or more of the processor(s) 714 or the memory 730. In one aspect, at least one of the network adapter(s) 718 can couple functionally the computing device 710 to one or more computing devices 770 via one or more traffic and signaling pipes 760 that can permit or facilitate exchange of traffic 762 and signaling 764 between the computing device 710 and the one or more computing devices 770. Such network coupling provided at least in part by the at least one of the network adapter(s) 718 can be implemented in a wired environment, a wireless environment, or both. The information that is communicated by the at least one network adapter can result from implementation of one or more operations in a method of the disclosure. Such output can be any form of visual representation, including, but not limited to, textual, graphical, animation, audio, tactile, and the like. In certain scenarios, the access point (AP), the stations (STAs), and/or other device can have substantially the same architecture as the computing device 710. In addition or in the alternative, the display unit(s) 726 can include functional elements (e.g., lights, such as light-emitting diodes; a display, such as liquid crystal display (LCD), combinations thereof, or the like) that can permit control of the operation of the computing device 710, or can permit conveying or revealing operational conditions of the computing device 710.

In one aspect, the bus 732 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 732, and all buses described herein can be implemented over a wired or wireless network connection and each of the subsystems, including the processor(s) 714, the memory 730 and memory elements therein, and the I/O interface(s) 716 can be contained within one or more remote computing devices 770 at physically separate locations, connected through buses of this form, in effect implementing a fully distributed system.

The computing device 710 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 710, and can comprise, for example, both volatile and non-volatile media, and removable and/or non-removable media. In one aspect, the memory 730 can comprise computer-readable media in the form of volatile memory, such as random access memory (RAM), and/or non-volatile memory, such as read only memory (ROM).

The memory 730 can comprise functionality instructions storage 734 and functionality information storage 738. The functionality instructions storage 734 can comprise computer-accessible instructions that, in response to execution (by at least one of the processor(s) 714), can implement one or more of the functionalities of the disclosure. The computer-accessible instructions can embody or can comprise one or more software components illustrated as auto-detection component(s) 736. In one scenario, execution of at least one component of the auto-detection component(s) 736 can implement one or more of the techniques disclosed herein. For instance, such execution can cause a processor that executes the at least one component to carry out a disclosed example method. It should be appreciated that, in one aspect, a processor of the processor(s) 714 that executes at least one of the auto-detection component(s) 736 can retrieve information from or retain information in a memory element 740 in the functionality information storage 738 in order to operate in accordance with the functionality programmed or otherwise configured by the auto-detection component(s) 736. Such information can include at least one of code instructions, information structures, or the like. At least one of the one or more interfaces 750 (e.g., application programming interface(s)) can permit or facilitate communication of information between two or more components within the functionality instructions storage 734. The information that is communicated by the at least one interface can result from implementation of one or more operations in a method of the disclosure. In certain embodiments, one or more of the functionality instructions storage 734 and the functionality information storage 738 can be embodied in or can comprise removable/non-removable, and/or volatile/non-volatile computer storage media.

At least a portion of at least one of the auto-detection component(s) 736 or auto-detection information 740 can program or otherwise configure one or more of the processors 714 to operate at least in accordance with the functionality described herein. One or more of the processor(s) 714 can execute at least one of such components and leverage at least a portion of the information in the storage 738 in order to provide auto-detection in accordance with one or more aspects described herein. More specifically, yet not exclusively, execution of one or more of the component(s) 736 can permit transmitting and/or receiving information at the computing device 710, as described in connection with FIGS. 1-4, for example.

It should be appreciated that, in certain scenarios, the functionality instruction(s) storage 734 can embody or can comprise a computer-readable non-transitory storage medium having computer-accessible instructions that, in response to execution, cause at least one processor (e.g., one or more of processor(s) 714) to perform a group of operations comprising the operations or blocks described in connection with the disclosed methods.

In addition, the memory 730 can comprise computer-accessible instructions and information (e.g., data and/or metadata) that permit or facilitate operation and/or administration (e.g., upgrades, software installation, any other configuration, or the like) of the computing device 710. Accordingly, as illustrated, the memory 730 can comprise a memory element 742 (labeled OS instruction(s) 742) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 710 can dictate a suitable OS. The memory 730 also comprises a system information storage 746 having data and/or metadata that permits or facilitate operation and/or administration of the computing device 710. Elements of the OS instruction(s) 742 and the system information storage 746 can be accessible or can be operated on by at least one of the processor(s) 714.

It should be recognized that while the functionality instructions storage 734 and other executable program components, such as the operating system instruction(s) 742, are illustrated herein as discrete blocks, such software components can reside at various times in different memory components of the computing device 710, and can be executed by at least one of the processor(s) 714. In certain scenarios, an implementation of the auto-detection component(s) 736 can be retained on or transmitted across some form of computer readable media.

The computing device 710 and/or one of the computing device(s) 770 can include a power supply (not shown), which can power up components or functional elements within such devices. The power supply can be a rechargeable power supply, e.g., a rechargeable battery, and it can include one or more transformers to achieve a power level suitable for operation of the computing device 710 and/or one of the computing device(s) 770, and components, functional elements, and related circuitry therein. In certain scenarios, the power supply can be attached to a conventional power grid to recharge and ensure that such devices can be operational. In one aspect, the power supply can include an I/O interface (e.g., one of the network adapter(s) 718) to connect operationally to the conventional power grid. In another aspect, the power supply can include an energy conversion component, such as a solar panel, to provide additional or alternative power resources or autonomy for the computing device 710 and/or one of the computing device(s) 770.

The computing device 710 can operate in a networked environment by utilizing connections to one or more remote computing devices 770. As an illustration, a remote computing device can be a personal computer, a portable computer, a server, a router, a network computer, a peer device or other common network node, and so on. As described herein, connections (physical and/or logical) between the computing device 710 and a computing device of the one or more remote computing devices 770 can be made via one or more traffic and signaling pipes 760, which can comprise wireline link(s) and/or wireless link(s) and several network elements (such as routers or switches, concentrators, servers, and the like) that form a local area network (LAN) and/or a wide area network (WAN). Such networking environments are conventional and commonplace in dwellings, offices, enterprise-wide computer networks, intranets, local area networks, and wide area networks.

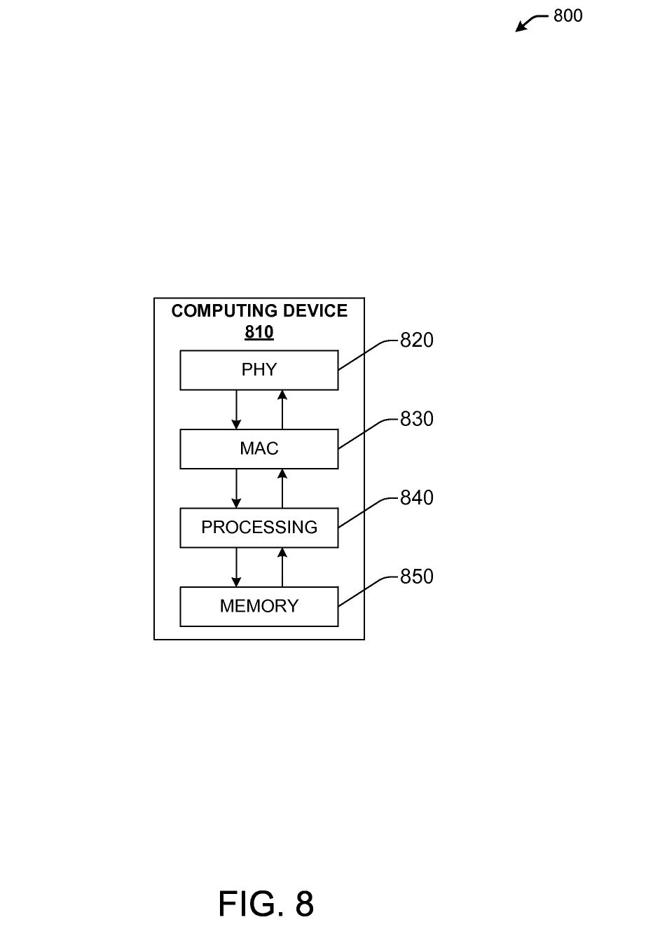

FIG. 8 presents another example embodiment 800 of a computing device 810 in accordance with one or more embodiments of the disclosure. In some embodiments, a sink device 110 or a source device 120 may be a computing device 810 as described herein. In certain implementations, the computing device 810 can be a highly efficient WLAN (HEW)-compliant device that may be configured to communicate with one or more other HEW devices and/or other types of communication devices, such as legacy communication devices. HEW devices and legacy devices also may be referred to as HEW stations (STAs) and legacy STAs, respectively. In one implementation, the computing device 810 can operate as an access point, an STA, and/or another device. As illustrated, the computing device 810 can include, among other things, physical layer (PHY) circuitry 820 and medium-access-control layer (MAC) circuitry 830. In one aspect, the PHY circuitry 810 and the MAC circuitry 830 can be HEW compliant layers and also can be compliant with one or more legacy IEEE 802.11 standards. In one aspect, the MAC circuitry 830 can be arranged to configure physical layer converge protocol (PLCP) protocol data units (PPDUs) and arranged to transmit and receive PPDUs, among other things. In addition or in other embodiments, the computing device 810 also can include other hardware processing circuitry 840 (e.g., one or more processors) and one or more memory devices 850 configured to perform the various operations described herein.

In certain embodiments, the MAC circuitry 830 can be arranged to contend for a wireless medium during a contention period to receive control of the medium for the HEW control period and configure an HEW PPDU. In addition or in other embodiments, the PHY 820 can be arranged to transmit the HEW PPDU. The PHY circuitry 820 can include circuitry for modulation/demodulation, upconversion/downconversion, filtering, amplification, etc. As such, the computing device 810 can include a transceiver to transmit and receive data such as HEW PPDU. In certain embodiments, the hardware processing circuitry 840 can include one or more processors. The hardware processing circuitry 840 can be configured to perform functions based on instructions being stored in a memory device (e.g., RAM or ROM) or based on special purpose circuitry. In certain embodiments, the hardware processing circuitry 840 can be configured to perform one or more of the functions described herein, such as activating and/or deactivating different back-off count procedures, allocating bandwidth, and/or the like.

In certain embodiments, one or more antennas may be coupled to or included in the PHY circuitry 820. The antenna(s) can transmit and receive wireless signals, including transmission of HEW packets. As described herein, the one or more antennas can include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 850 can retain or otherwise store information for configuring the other circuitry to perform operations for configuring and transmitting HEW packets and performing the various operations described herein including the allocation of and using of bandwidth (AP) and using the allocation of the bandwidth (STA), facilitating generation and transmission of a content stream from a source device 120 to a sink device 110, facilitating capture and transmission of

The computing device 810 can be configured to communicate using OFDM communication signals over a multicarrier communication channel. More specifically, in certain embodiments, the computing device 810 can be configured to communicate in accordance with one or more specific radio technology protocols, such as the IEEE family of standards including IEEE 802.11-2012, IEEE 802.11n-2009, IEEE 802.11ac-2013, IEEE 802.11ax, DensiFi, and/or proposed specifications for WLANs. In one of such embodiments, the computing device 810 can utilize or otherwise rely on symbols having a duration that is four times the symbol duration of IEEE 802.11n and/or IEEE 802.11ac. It should be appreciated that the disclosure is not limited in this respect and, in certain embodiments, the computing device 810 also can transmit and/or receive wireless communications in accordance with other protocols and/or standards.

The computing device 810 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11 or IEEE 802.16, or other types of communication device that may receive and/or transmit information wirelessly. Similarly to the computing device 710, the computing device 810 can include, for example, one or more of a keyboard, a display, a non-volatile memory port, multiple antennas, a graphics processor, an application processor, speakers, and other mobile device elements. The display may be an LCD screen including a touch screen.

It should be appreciated that while the computing device 810 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In certain embodiments, the functional elements may refer to one or more processes operating or otherwise executing on one or more processors.

In one embodiment, a computer-readable non-transitory storage medium may contains instructions, which when executed by one or more processors result in performing operations comprising establishing a wireless connection with a sink device; generating a video content stream corresponding to content presented on a source device display; causing to transmit the video content stream to the sink device; identifying a data packet received from the sink device, the data packet comprising sensor data; generating an updated video content stream using the sensor data; and causing to transmit the updated video content stream to the sink device.

In one aspect of an embodiment, the operations may further comprise processing the sensor data; and injecting the sensor data into an input system of a corresponding sensor of the source device. In one aspect of an embodiment, the operations may further comprise initiating a Transmission Control Protocol (TCP) connection with the sink device; and wherein identifying the data packet comprising the sensor data captured by the sink device comprising identifying the data packet using a User Input Back Channel (UIBC) protocol via the TCP connection. In one aspect of an embodiment, the operations may further comprise querying the sink device to determine that the sink device supports a User Input Back Channel (UIBC) protocol; identifying a list of supported input types received from the sink device; and causing to transmit a request to the sink device to send inputs for a subset of the supported input types; wherein the sensor data is associated with a supported input type from the list of supported input types. In one aspect of an embodiment, the list of supported input types may comprise at least one of gyroscope, accelerometer, ambient temperature, gravity, light, magnetic field, orientation, pressure, proximity, relative humidity, or vendor-specific. In one aspect of an embodiment, the operations may further comprise disabling at least one sensor corresponding to a sensor of the sink device capturing sensor data. In one aspect of an embodiment, the operations may further comprise causing to transmit the video content stream to a second sink device; identifying a second data packet received from the second sink device, the second data packet comprising a second sensor data; determining the second sensor data from the second data packet; generating a second updated video content stream using the second sensor data; and causing to transmit the second updated video content stream to the sink device and the second sink device.

In one embodiment, a system may comprise at least one sensor; at least one memory storing computer-executable instructions; and at least one processor, wherein the at least one processor is configured to access the at least one memory and to execute the computer-executable instructions to establish a wireless connection with a sink device; generate a video content stream corresponding to content presented on a source device display; cause to transmit of the video content stream to the sink device; identify a data packet received from the sink device, the data packet comprising sensor data; generate an updated video content stream using the sensor data; and cause to transmit the updated video content stream to the sink device.

In one aspect of an embodiment, the at least one processor may be configured to access the at least one memory and to execute the computer-executable instructions to process the sensor data; and inject the sensor data into an input system of a corresponding sensor of the source device. In one aspect of an embodiment, the at least one processor may be configured to access the at least one memory and to execute the computer-executable instructions to initiate a Transmission Control Protocol (TCP) connection with the sink device; and wherein, to identify the data packet comprising the sensor data captured by the sink device further comprises identifying the data packet using a User Input Back Channel (UIBC) protocol via the TCP connection. In one aspect of an embodiment, the at least one processor may be configured to access the at least one memory and to execute the computer-executable instructions to query the sink device to determine that the sink device supports a User Input Back Channel (UIBC) protocol; identify a list of supported input types received from the sink device; and cause to transmit a request to the sink device to send inputs for a subset of the supported input types; wherein the sensor data is associated with a supported input type from the list of supported input types. In one aspect of an embodiment, the list of supported input types comprises at least one of gyroscope, accelerometer, ambient temperature, gravity, light, magnetic field, orientation, pressure, proximity, relative humidity, or vendor-specific. In one aspect of an embodiment, the at least one processor may be configured to access the at least one memory and to execute the computer-executable instructions todisable at least one sensor corresponding to a sensor of the sink device capturing sensor data. In one aspect of an embodiment, the at least one processor may be configured to access the at least one memory and to execute the computer-executable instructions to cause to transmit the video content stream to a second sink device; identify a second data packet received from the second sink device, the second data packet comprising a second sensor data; determine the second sensor data from the second data packet; generate a second updated video content stream using the second sensor data; and cause to transmit the second updated video content stream to the sink device and the second sink device.

In one embodiment, a method may comprise establishing a wireless connection with a sink device; generating a video content stream corresponding to content presented on a source device display; causing to transmit the video content stream to the sink device; identifying a data packet received from the sink device, the data packet comprising sensor data; generating an updated video content stream using the sensor data; and causing to transmit the updated video content stream to the sink device.

In one aspect of an embodiment, the method may further comprise processing the sensor data; and injecting the sensor data into an input system of a corresponding sensor of the source device. In one aspect of an embodiment, the method may further comprise initiating a Transmission Control Protocol (TCP) connection with the sink device; and wherein identifying the data packet comprising the sensor data captured by the sink device comprising identifying the data packet using a User Input Back Channel (UIBC) protocol via the TCP connection. In one aspect of an embodiment, the method may further comprise querying the sink device to determine that the sink device supports a User Input Back Channel (UIBC) protocol; identifying a list of supported input types received from the sink device; and causing to transmit a request to the sink device to send inputs for a subset of the supported input types; wherein the sensor data is associated with a supported input type from the list of supported input types.

In one embodiment, an apparatus may comprise at least one sensor; at least one memory storing computer-executable instructions; and at least one processor, wherein the at least one processor is configured to access the at least one memory and to execute the computer-executable instructions to establish a wireless connection with a source device; receive a video content stream corresponding to content presented on a source device display; capture sensor data using the at least one sensor; generate a data packet comprising the sensor data; cause to transmit the data packet to the source device; and receive an updated video content stream from the source device, wherein the updated video stream was generated using the sensor data.

In one aspect of an embodiment, the at least one processor may be configured to access the at least one memory and to execute the computer-executable instructions to receive a query request from the source device requesting information associated with support for User Input Back Channel (UIBC) protocol; generate a list of supported input types; cause to transmit the list to the source device; receive a request to the sink device to send inputs for a subset of the supported input types; generate the data packet comprising the sensor data, wherein the sensor data is associated with a supported input type from the list of supported input types; and cause to transmit the data packet to the source device.

In one embodiment, a system may comprise a means for establishing a wireless connection with a sink device; a means for generating a video content stream corresponding to content presented on a source device display; a means for causing to transmit the video content stream to the sink device; a means for identifying a data packet received from the sink device, the data packet comprising sensor data; a means for generating an updated video content stream using the sensor data; and a means for causing to transmit the updated video content stream to the sink device.

In one aspect of an embodiment, the system may comprise a means for processing the sensor data; and a means for injecting the sensor data into an input system of a corresponding sensor of the source device. The system may further comprise a means for initiating a Transmission Control Protocol (TCP) connection with the sink device; and wherein the means for identifying the data packet comprising the sensor data captured by the sink device comprising a means for identifying the data packet using a User Input Back Channel (UIBC) protocol via the TCP connection. In one aspect of an embodiment, the system may further comprise a means for querying the sink device to determine that the sink device supports a User Input Back Channel (UIBC) protocol; a means for identifying a list of supported input types received from the sink device; and a means for causing to transmit a request to the sink device to send inputs for a subset of the supported input types; wherein the sensor data is associated with a supported input type from the list of supported input types.

In one embodiment, an apparatus may comprise at least one sensor; at least one memory storing computer-executable instructions; and at least one processor, wherein the at least one processor is configured to access the at least one memory and to execute the computer-executable instructions to establish a wireless connection with a sink device; generate a video content stream corresponding to content presented on a source device display; cause to transmit the video content stream to the sink device; identify a data packet received from the sink device, the data packet comprising sensor data; generate an updated video content stream using the sensor data; and cause to transmit the updated video content stream to the sink device.

In one aspect of an embodiment, the at least one processor may be configured to access the at least one memory and to execute the computer-executable instructions to process the sensor data; and inject the sensor data into an input system of a corresponding sensor of the source device. In one aspect of an embodiment, the at least one processor may be configured to access the at least one memory and to execute the computer-executable instructions to initiate a Transmission Control Protocol (TCP) connection with the sink device; and wherein to identify the data packet comprising the sensor data captured by the sink device further comprises identifying the data packet using a User Input Back Channel (UIBC) protocol via the TCP connection. In one aspect of an embodiment, the at least one processor may be configured to access the at least one memory and to execute the computer-executable instructions to query the sink device to determine that the sink device supports a User Input Back Channel (UIBC) protocol; identify a list of supported input types received from the sink device; and cause to transmit a request to the sink device to send inputs for a subset of the supported input types; wherein the sensor data is associated with a supported input type from the list of supported input types.

### CONCLUSION

Various embodiments of the disclosure may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A computer-readable non-transitory storage medium that contains instructions, which when executed by one or more processors result in performing operations comprising:
establishing a wireless connection with a sink device;
generating a video content stream corresponding to content presented on a source device display;
causing to transmit the video content stream to the sink device;
identifying a data packet received from the sink device, the data packet comprising sensor data;
generating an updated video content stream using the sensor data; and
causing to transmit the updated video content stream to the sink device.

2. The computer-readable non-transitory storage medium of claim 1, wherein the operations further comprise:
processing the sensor data; and
injecting the sensor data into an input system of a corresponding sensor of the source device.

3. The computer-readable non-transitory storage medium of claim 1, wherein the operations further comprise:
initiating a Transmission Control Protocol (TCP) connection with the sink device; and
wherein identifying the data packet comprising the sensor data captured by the sink device comprising identifying the data packet using a User Input Back Channel (UIBC) protocol via the TCP connection.

4. The computer-readable non-transitory storage medium of claim 1, wherein the operations further comprise:
querying the sink device to determine that the sink device supports a User Input Back Channel (UIBC) protocol;
identifying a list of supported input types received from the sink device; and
causing to transmit a request to the sink device to send inputs for a subset of the supported input types;
wherein the sensor data is associated with a supported input type from the list of supported input types.

5. The computer-readable non-transitory storage medium of claim 4, wherein the list of supported input types comprises at least one of gyroscope, accelerometer, ambient temperature, gravity, light, magnetic field, orientation, pressure, proximity, relative humidity, or vendor-specific.

6. The computer-readable non-transitory storage medium of claim 1, wherein the operations further comprise:
disabling at least one sensor corresponding to a sensor of the sink device capturing sensor data.

7. The computer-readable non-transitory storage medium of claim 1, wherein the operations further comprise:
causing to transmit the video content stream to a second sink device;
identifying a second data packet received from the second sink device, the second data packet comprising a second sensor data;
determining the second sensor data from the second data packet;
generating a second updated video content stream using the second sensor data; and
causing to transmit the second updated video content stream to the sink device and the second sink device.

8. A system comprising:
at least one sensor;
at least one memory storing computer-executable instructions; and
at least one processor, wherein the at least one processor is configured to access the at least one memory and to execute the computer-executable instructions to:
establish a wireless connection with a sink device;
generate a video content stream corresponding to content presented on a source device display;
cause to transmit of the video content stream to the sink device;
identify a data packet received from the sink device, the data packet comprising sensor data;
generate an updated video content stream using the sensor data; and
cause to transmit the updated video content stream to the sink device.

9. The system of claim 8, wherein the at least one processor is configured to access the at least one memory and to execute the computer-executable instructions to:
process the sensor data; and
inject the sensor data into an input system of a corresponding sensor of the source device.

10. The system of claim 8, wherein the at least one processor is configured to access the at least one memory and to execute the computer-executable instructions to:
initiate a Transmission Control Protocol (TCP) connection with the sink device; and
wherein, to identify the data packet comprising the sensor data captured by the sink device further comprises identifying the data packet using a User Input Back Channel (UIBC) protocol via the TCP connection.

11. The system of claim 8, wherein the at least one processor is configured to access the at least one memory and to execute the computer-executable instructions to:
query the sink device to determine that the sink device supports a User Input Back Channel (UIBC) protocol;
identify a list of supported input types received from the sink device; and
cause to transmit a request to the sink device to send inputs for a subset of the supported input types;
wherein the sensor data is associated with a supported input type from the list of supported input types.

12. The system of claim 11, wherein the list of supported input types comprises at least one of gyroscope, accelerometer, ambient temperature, gravity, light, magnetic field, orientation, pressure, proximity, relative humidity, or vendor-specific.

13. The system of claim 8, wherein the at least one processor is configured to access the at least one memory and to execute the computer-executable instructions to:
disable at least one sensor corresponding to a sensor of the sink device capturing sensor data.

14. The system of claim 8, wherein the at least one processor is configured to access the at least one memory and to execute the computer-executable instructions to:
cause to transmit the video content stream to a second sink device;
identify a second data packet received from the second sink device, the second data packet comprising a second sensor data;
determine the second sensor data from the second data packet;
generate a second updated video content stream using the second sensor data; and
cause to transmit the second updated video content stream to the sink device and the second sink device.

15. A method comprising:
establishing a wireless connection with a sink device;
generating a video content stream corresponding to content presented on a source device display;
causing to transmit the video content stream to the sink device;
identifying a data packet received from the sink device, the data packet comprising sensor data;
generating an updated video content stream using the sensor data; and
causing to transmit the updated video content stream to the sink device.

16. The method of claim 15, further comprising:
processing the sensor data; and
injecting the sensor data into an input system of a corresponding sensor of the source device.

17. The method of claim 15, further comprising:
initiating a Transmission Control Protocol (TCP) connection with the sink device; and
wherein identifying the data packet comprising the sensor data captured by the sink device comprising identifying the data packet using a User Input Back Channel (UIBC) protocol via the TCP connection.

18. The method of claim 15, further comprising:
querying the sink device to determine that the sink device supports a User Input Back Channel (UIBC) protocol;
identifying a list of supported input types received from the sink device; and
causing to transmit a request to the sink device to send inputs for a subset of the supported input types;
wherein the sensor data is associated with a supported input type from the list of supported input types.

19. An apparatus comprising:
at least one sensor;
at least one memory storing computer-executable instructions; and
at least one processor, wherein the at least one processor is configured to access the at least one memory and to execute the computer-executable instructions to:
establish a wireless connection with a source device;
receive a video content stream corresponding to content presented on a source device display;
capture sensor data using the at least one sensor;
generate a data packet comprising the sensor data;
cause to transmit the data packet to the source device; and
receive an updated video content stream from the source device, wherein the updated video stream was generated using the sensor data.

20. The apparatus of claim 19, wherein the at least one processor is configured to access the at least one memory and to execute the computer-executable instructions to:
receive a query request from the source device requesting information associated with support for User Input Back Channel (UIBC) protocol;
generate a list of supported input types;
cause to transmit the list to the source device;
receive a request to the sink device to send inputs for a subset of the supported input types;
generate the data packet comprising the sensor data, wherein the sensor data is associated with a supported input type from the list of supported input types; and
cause to transmit the data packet to the source device.
